(19) United States
(12) Patent Application Publication
(10) Pub. No.: US 2021/0254353 A1
(43) Pub. Date: Aug. 19, 2021

(54) PLASTIC FORM AND MANUFACTURING METHOD THEREOF

(71) Applicant: Yu-Tsai WU, New Taipei City (TW)

(72) Inventor: Yu-Tsai WU, New Taipei City (TW)

(21) Appl. No.: 16/790,753

(22) Filed: Feb. 14, 2020

(51) Int. Cl. E04G 9/05; B29C 48/11; B29C 48/21; B29C 48/495; B29C 48/17

(52) U.S. Cl. CPC E04G 9/05; B29C 48/11; B29K 2069/00; B29C 48/495; B29C 48/17; B29C 48/21

(57) ABSTRACT

A plastic form and its manufacturing process are disclosed. The process involves a single-screw extruder and a twin-screw extruder in mixing a first material and a second material, and a hydraulic distributor evenly distributing the first and second materials to a mesh forming machine to produce the plastic form. The plastic form has a mesh structure by a first piece, a second piece, multiple first partitions, at least a second partition, multiple channels. The first and second materials respectively include at least one of PP particles, PE particles, PC particles, PA particles, ABS resin particles, fiberglass particles, and stone powder, in accordance with application requirement. The plastic form has advantages such as high structural strength, impact resistance, adhesion, hardness, anti-skidding, and flame retarding. As recycled materials are used, the plastic form is also inexpensive and environmentally friendly.

### BACKGROUND OF THE INVENTION

### (a) Technical Field of the Invention

The present invention generally relates to formworks and, more particularly, to a plastic form that is low-cost, high-strength, and its manufacturing method.

### (b) Description of the Prior Art

Grouting is usually used to form columns or walls of a concrete building by using forms to shape the columns or walls, pouring grout inside, and removing the forms after the grout is dried.

Conventionally, there are timber forms, metallic forms, and plastic forms for concrete construction formworks. For timber forms, as they are water-absorbent and their surfaces may be as such roughened, usually there is a need for a treatment to flatten the surface of the finished concrete object, which are time-consuming and laborious. The stripped timber forms may be reused for only limited times. After that, the forms have to be abandoned, leading to high cost and environment unfriendliness. As to metallic forms, their heavy weight requires machine loading and transportation, introducing higher construction difficulty and hazard. Metallic forms also cannot be processed in situ, and are mostly applied to constructions such as bridges, piers, ditches that require the forms to withstand heavy load. The plastic forms are less robust and may be damaged due to external impact or falling in the construction site. If composite plastic material is used, there is higher cost involved, and its quality from blending various materials is difficult to control.

### SUMMARY OF THE INVENTION

A major objective of the present invention is to use various recycled materials according to application requirements, and combine these recycled materials through the employment of a single-screw extruder and a twin-screw extruder, into a plastic form of low cost, reduced pollution, high strength, impact resistance, adhesion, hardness, flame retarding, and anti-skidding.

The plastic form mainly includes an integrally formed flat main member which includes a first piece, a second piece facing the first piece in parallel, multiple first partitions fixedly arranged in parallel and at intervals between and perpendicularly connecting the first piece and the second piece, at least one second partition perpendicularly crossing the first partitions, and multiple channels, each surrounded by the first partitions and the at least one second partition with two openings respectively at its two ends. The main member therefore has a mesh structure between the first and second pieces. Depending on the application of the plastic form, the main member may include PC particles, mixed PC and ABS resin particles, or PA particles. The first piece and second piece may include mixed PC and fiberglass particles, mixed PC, ABS resin and fiberglass particles, or mixed PA and fiberglass particles. Alternatively, a first solid plate and a second solid plate may be respectively formed outside the first piece and the second piece. With this arrangement, the main member include mixed PP and PE particles, and the first solid plate and the second solid plate include mixed PP, stone powder, and fiberglass.

The plastic form is manufactures by the following steps: (a) blending a first material and disposing the first material inside a single-screw extruder for melting; (b) blending a second material and disposing the second material inside a twin-screw extruder for melting; (c) evenly distributing the first material by at least one hydraulic distributor to an upper forming member and a lower forming member of a mesh forming machine; (d) evenly delivering the second material by the at least one hydraulic distributor to a mesh forming member of the mesh forming machine; (e) cooling and setting the first material and the second material by a cooling device after being output from the mesh forming machine; and (f) producing a first piece from the upper forming member, a second piece from the lower forming member, a main member from the mesh forming member, and integrally forming the plastic form through the first piece, the second piece, and the main member. Depending on the application, the first material and second material are respectively blended by single-screw extruder and twin-screw extruder using various recycled materials. Then, hydraulic distributors, mesh forming machine, and cooling device are employed to continuously produce main member. The plastic form therefore has low production cost, convenient process, and, based on the materials used, may have various properties such as high structural strength, impact resistance, adhesion, hardness, and anti-skidding, flame retarding, etc.

The plastic form of the present invention therefore resolves the conventional problems such as the need for smoothing the finished concrete work, the difficulty in recycling, the inconvenient transportation and work due to heavy weight, high cost, etc.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a plastic form according to a first embodiment of the present invention.

FIG. 2 is a top-view diagram showing the plastic form of FIG. 1.

FIG. 3 is a flow diagram showing the steps of manufacturing the plastic form of FIG. 1.

FIG. 4 is a perspective diagram showing the various machines for manufacturing the plastic form of FIG. 1.

FIG. 5 is a perspective diagram showing a scenario of extruders of FIG. 4 in manufacturing the plastic form of FIG. 1.

FIG. 6 is a perspective diagram showing a scenario of hydraulic distributors of FIG. 4 in manufacturing the plastic form of FIG. 1.

FIG. 7 is a perspective diagram showing a mesh forming machine of FIG. 4.

FIG. 8 is a top-view diagram showing a plastic form according to a second embodiment of the present invention.

FIG. 9 is a perspective diagram showing a plastic form according to a third embodiment of the present invention.

FIG. 10 is a top-view diagram showing the plastic form of FIG. 9.

FIG. 11 is a perspective diagram showing a plastic form according to a fourth embodiment of the present invention.

FIG. 12 is a top-view diagram showing the plastic form of FIG. 11.

FIG. 13 is a perspective diagram showing a plastic form according to a fifth embodiment of the present invention.

FIG. 14 is a top-view diagram showing the plastic form of FIG. 13.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

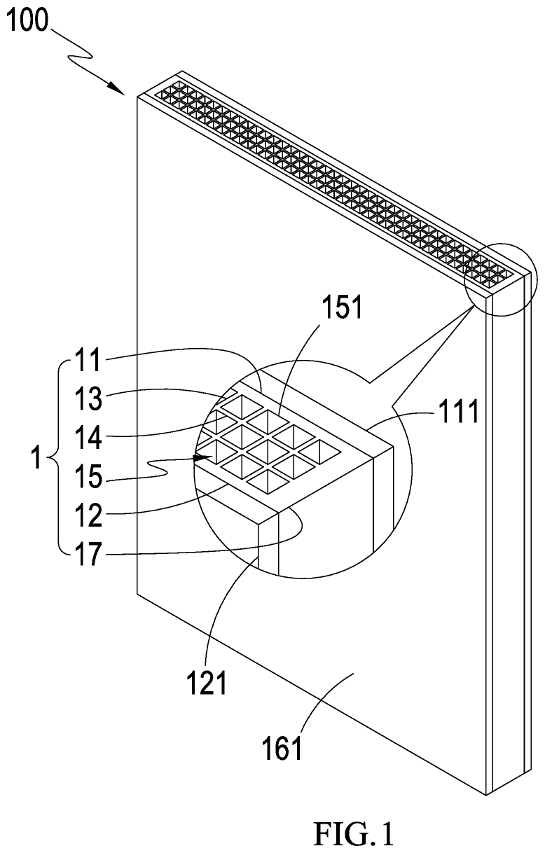

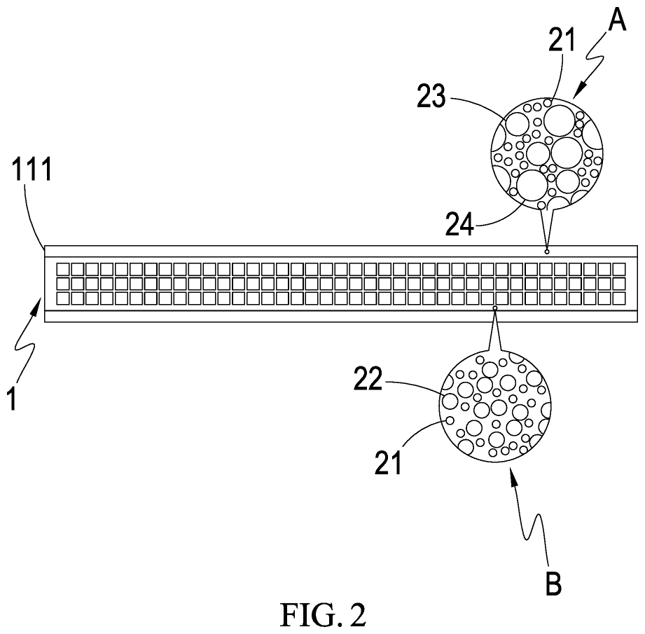

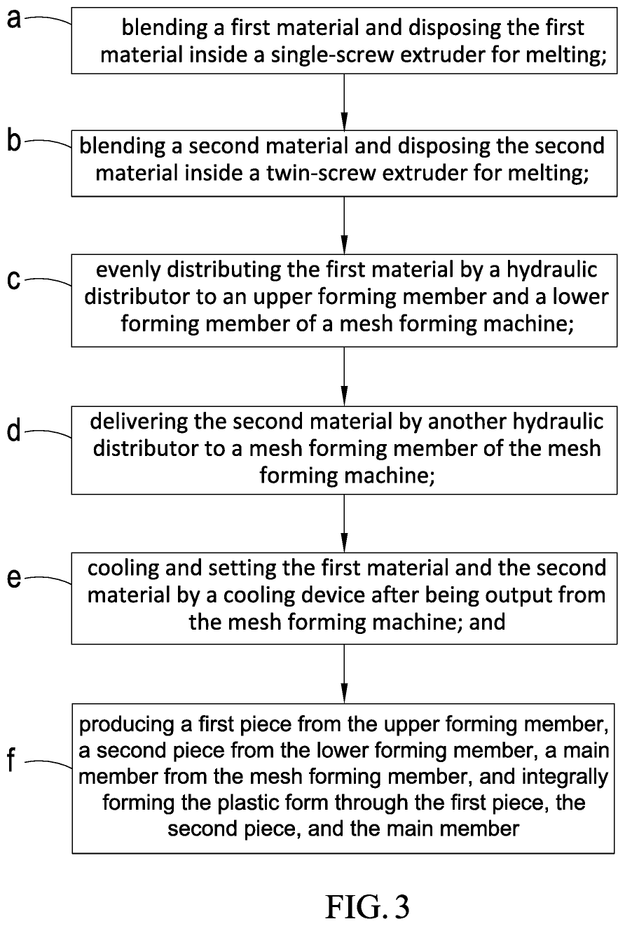

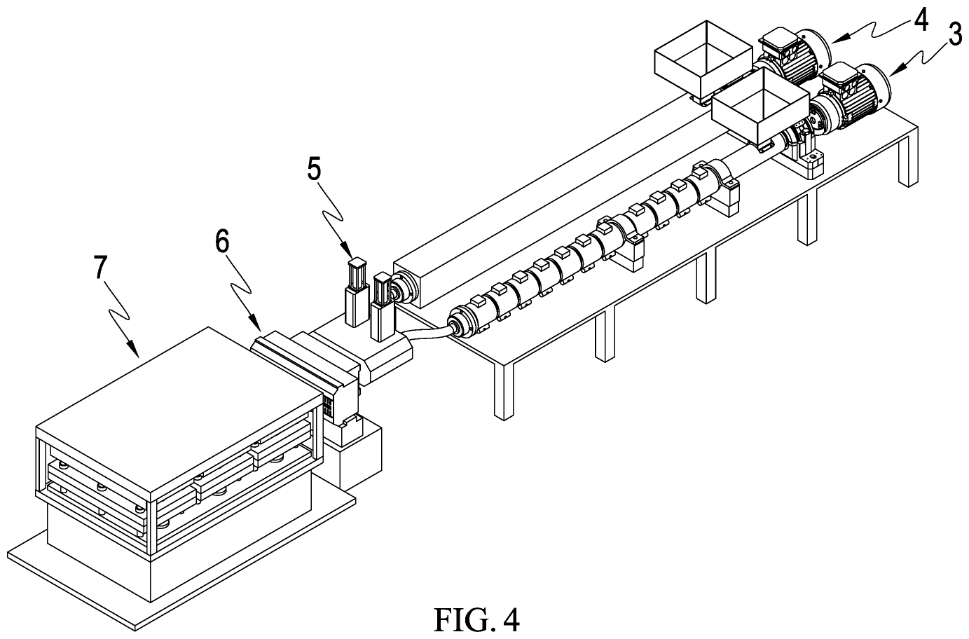

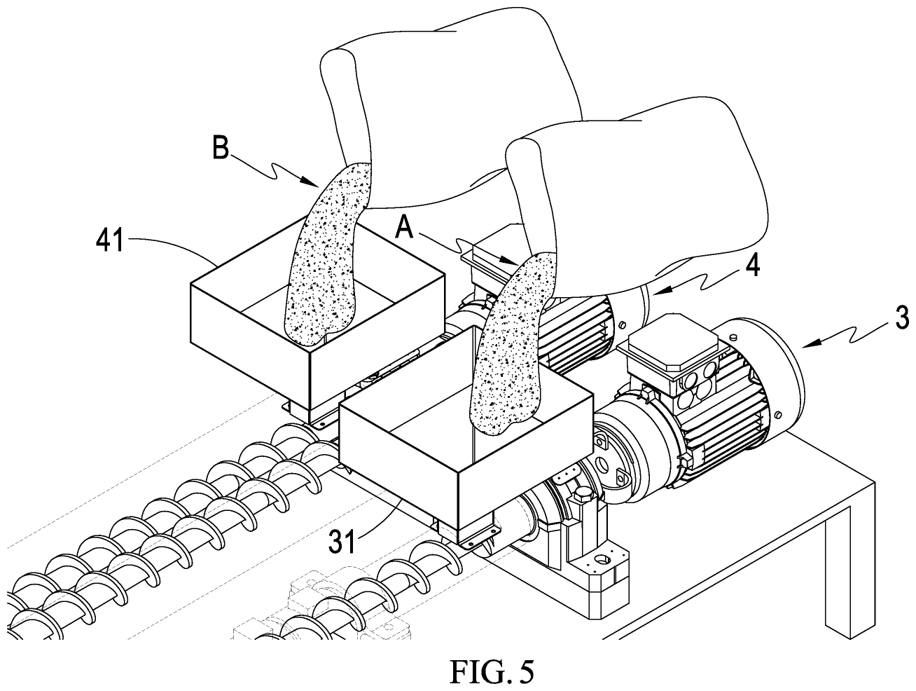

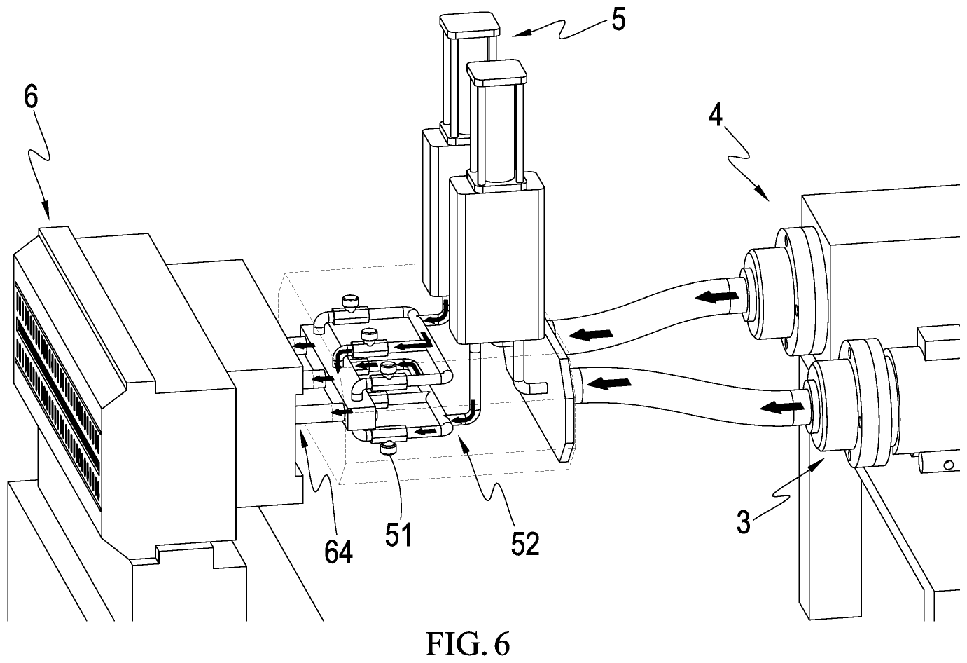

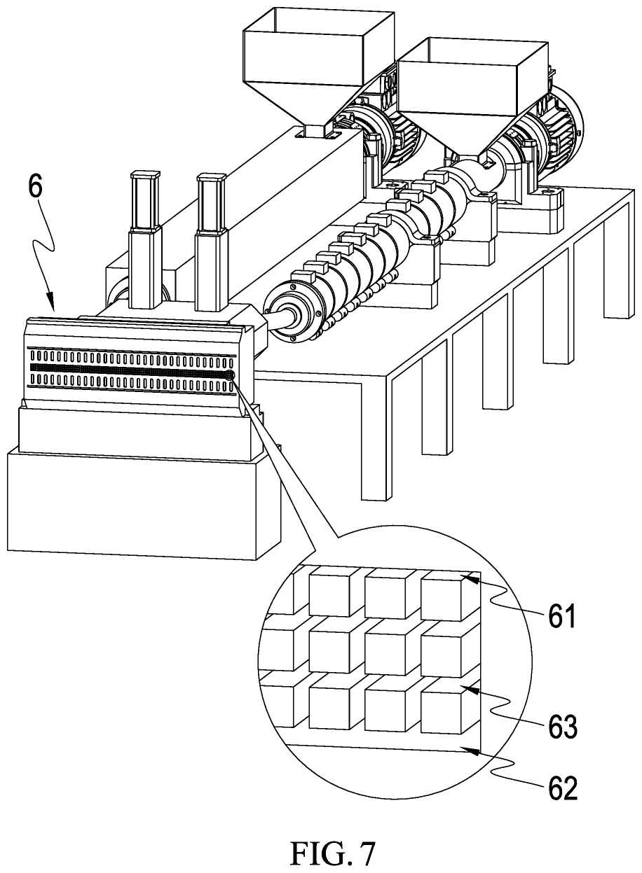

As shown in FIGS. 1 to 7, a plastic form 100 according to a first embodiment of the present invention includes the following components.

An integrally formed flat main member 1 includes a flat first piece 11, a flat second piece 12 facing the first piece 11 in parallel, a number of flat first partitions 13 fixedly arranged in parallel and at intervals between and perpendicularly connecting the first piece 11 and the second piece 12, a number of second partitions 14, each perpendicularly crossing the first partitions 13, and a number of channels 15, each surrounded by the first partitions 13 and second partitions 14 with two openings 151 respectively at its two ends. The main member 1 therefore has a mesh structure between the first and second pieces 11 and 12.

A first solid plate 111 is flatly attached to an upper surface of the first piece 11.

A second solid plate 121 is flatly attached to a lower surface of the second piece 12.

Two solid lateral pieces 17 are respectively disposed at two lateral sides of the main member 1.

There are multiple recycled polypropylene (PP) particles 21 inside the main member 1, the first solid plate 111, and the second solid plate 121.

The main member 1 also includes multiple recycled polyethylene (PE) particles 22, in addition to the PP particles 21.

The first solid plate 111 and the second solid plate 121 also includes stone powder 23, in addition to the PP particles 21.

The first solid plate 111 and the second solid plate 121 further includes multiple fiberglass particles 24.

Multiple roughened faces 161 are configured on outer surfaces of the first solid plate 111 and the second solid plate 121.

The plastic form of the present invention is manufactured by the following steps:

(a) blending a first material and disposing the first material inside a single-screw extruder for melting;

(b) blending a second material and disposing the second material inside a twin-screw extruder for melting;

(c) evenly distributing the first material by a hydraulic distributor to an upper forming member and a lower forming member of a mesh forming machine;

(d) delivering the second material by another hydraulic distributor to a mesh forming member of the mesh forming machine;

(e) cooling and setting the first material and the second material by a cooling device after being output from the mesh forming machine; and

(f) producing a first piece from the upper forming member, a second piece from the lower forming member, a main member from the mesh forming member, and integrally forming the plastic form through the first piece, the second piece, and the main member, where the main member includes a number of flat first partitions fixedly arranged in parallel and at intervals between and perpendicularly connecting the first piece and the second piece, a number of second partitions, each perpendicularly crossing the first partitions, and a number of channels, each surrounded by the first partitions and second partitions with two openings respectively at its two ends. The main member therefore has a mesh structure.

As described above, the present invention relies on twin-screw and single-screw extruders to integrally form a low-cost, high-strength plastic form 100. More details are given as follows.

The first and second solid plate 111, 121 are made from recycled materials so as to reduce cost (which is about 1/10 to that of new materials), and to enhance environmental friendliness. In addition, stone powder 23, fiberglass particles 24, and acrylonitrile butadiene styrene (ABS) resin 26 may be included and blended to produce plastic forms 100 for various applications.

For the present embodiment, the first material A for the first and second solid plate 111, 121 includes mixed PP particles 21, stone powder 23, and fiberglass particles 24. The second material B for the main member 1 includes mixed PP particles 21 and PE particles 22. A common characteristic to the PP particles 21 and PE particles 22 is their good adhesive property. Blending the two together contribute to the plastic form's robustness and the plastic form is not easily broken during the construction process. Also, nails driven through the plastic form do not fall off easily, thereby maintaining the construction quality. This approach also avoids problems such as the high cost of using only PP and the lack of resistance to high temperature using only PE. Further adding stone powder 23 and fiberglass particles 24 into the first solid plate 111, the second solid plate 121, and even the solid lateral pieces 17 further enhance the plastic form's capability in withstanding impact, thereby increasing its performance for cushion. The fiberglass particles 24 also help to achieve roughened faces 161 on the first solid plate 111 and second solid plate 121 for anti-skidding.

In the manufacturing process, the first material A is poured into a feeder 31 of the single-screw extruder 3, and melted and delivered by the single-screw extruder 3 into a hydraulic distributor 5. The second material B is poured into a feeder 41 of the twin-screw extruder 4, and melted and delivered by the twin-screw extruder 4 into another hydraulic distributor 5. Then, the first material A is evenly distributed to the upper forming member 61 and the lower forming member 62 of the mesh forming machine 6 by the hydraulic distributor 5. The second material B is evenly distributed the mesh forming member 63 of the mesh forming machine 6. The hydraulic distributors 5 turn on or off their various valves 51 so as to guide the flow of the first material A and the second material B. For example, if the inlet ports 64 to the upper forming member 61 and the lower forming member 62 are respectively located to the left and right sides, the hydraulic distributor 5 corresponding to the single-screw extruder 3 only turns on the inlet pipes 52 to the left and right sides Similarly, if inlet port 64 to the mesh forming member 63 is located in the middle, the hydraulic distributor 5 corresponding to the twin-screw extruder 4 turns on the middle inlet pipe 52. The mesh forming machine 6 then connects or disconnects its various output ports to produce the various parts of the plastic form. For example, by connecting the uppermost row of output ports of upper forming member 61, and connecting the lowermost row of output ports of the lower forming member 62, the first solid plate 111 and the second solid plate 121 are produced Similarly, by connecting the output ports along the lateral sides of the mesh forming member 63, the solid lateral pieces 17 are produced. These operations of mesh forming machine 6 are known to people of the related art and their details are omitted. Then, the first material A and the second material B, after being output from the mesh forming machine 6 and cooled and set by the cooling device 7, produce the first piece 11 (including the first solid plate 111) from the upper forming member 61, the second piece 12 (including the second solid plate 121) from the lower forming member 62, the main member 1 (solid lateral piece 17) from the mesh forming member 63, and integrally form the plastic form 100 from the first piece 11, the second piece 12, and the main member 1. The main member includes a number of flat first partitions 13 fixedly arranged in parallel and at intervals between and perpendicularly connecting the first piece 11 and the second piece 12, a number of second partitions 14, each perpendicularly crossing the first partitions 13, and a number of channels 15, each surrounded by the first partitions 13 and second partitions 14. The main member therefore has a mesh structure. In the present embodiment, the mesh structure involves two second partitions 14 and, therefore, three layers of channels 15.

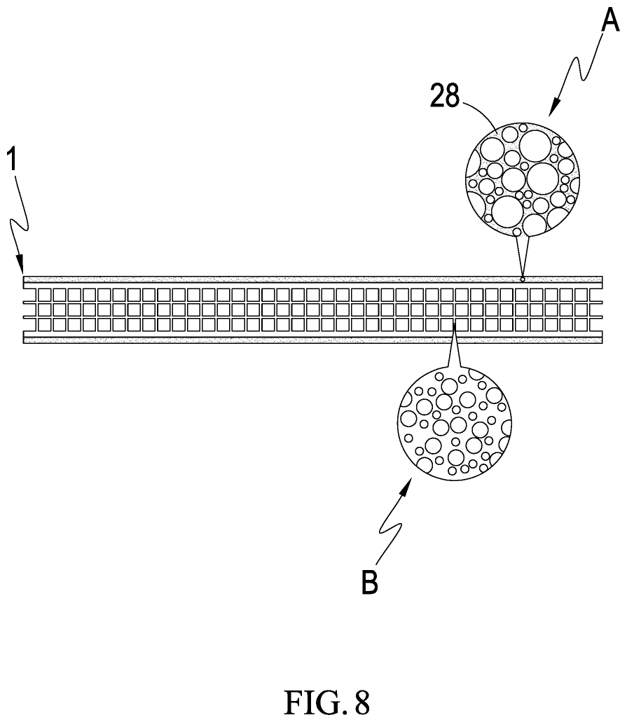

As shown in FIG. 8, a plastic form according to a second embodiment of the present invention is produced, as described above, by turning off the output of the solid lateral pieces from the mesh forming machine. In the present embodiment, a dye 28 is blended in the first material A so that the first material A and the second material B have different colors, not only achieving visual appealing but also enhancing identification by construction workers.

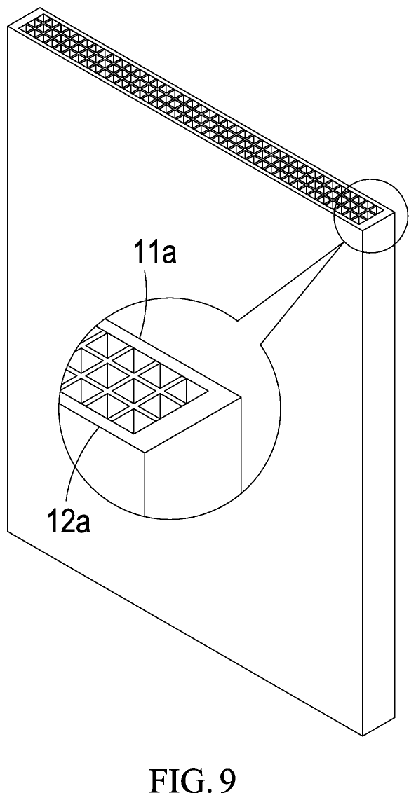

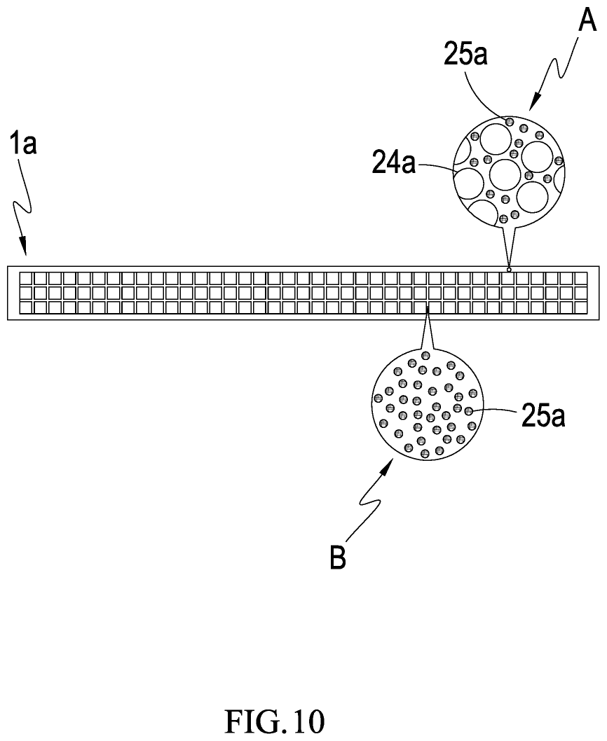

As shown in FIGS. 9 and 10, a plastic form according to a third embodiment is similar to the previous embodiments except that the first material A now includes mixed recycled polycarbonate (PC) particles 25a and fiberglass particles 24a, and the second material B now includes PC particles 25a. PC is thermal plastic material resistant to acid, oil, heat, and impact. Its use in the mesh structure of the main member la enhances structural strength and robustness to impact. The fiberglass particles 24a in the first material A further enhance structural strength and anti-skidding capability. In addition, by using the first material A in the first piece 11a and second piece 12a, the first solid plate and the second solid plate are omitted, thereby achieving smaller thickness while maintaining structural strength.

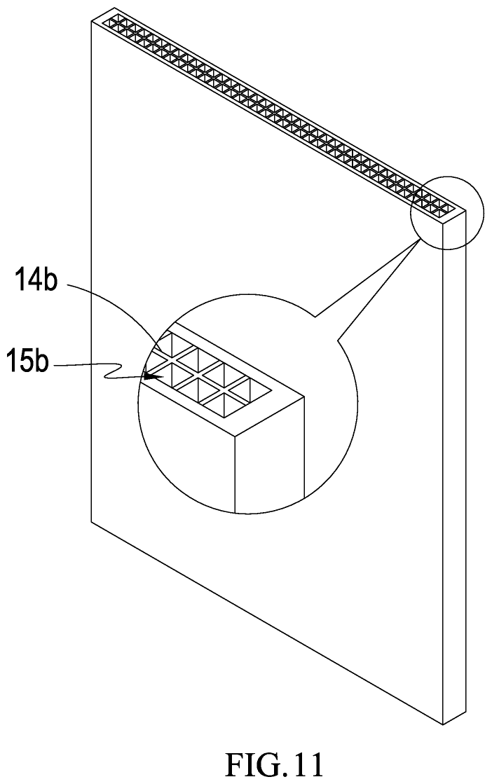

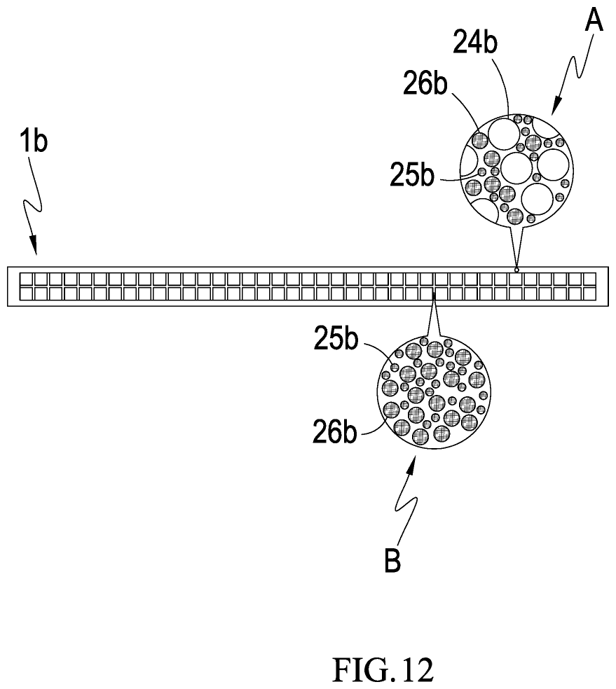

As shown in FIGS. 11 and 12, a plastic form according to a fourth embodiment is similar to the previous embodiments except that the first material A now includes mixed PC particles 25b, ABS resin particles 26b and fiberglass particles 24b, and the second material B includes mixed PC particles 25b and ABS resin particles 26b. There is only a single second partition 14b and therefore two layers of channels 15b. ABS resin is heat-resistant, high-hardness, acid and alkali-resistant, and has smooth surface. Adding ABS resin particles 26b in the first material A and second material B improves the structural strength of the main member 1b and its surface gloss.

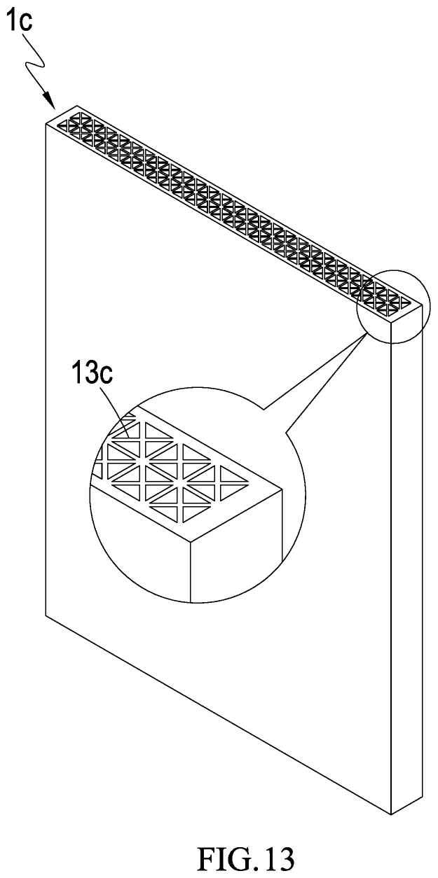

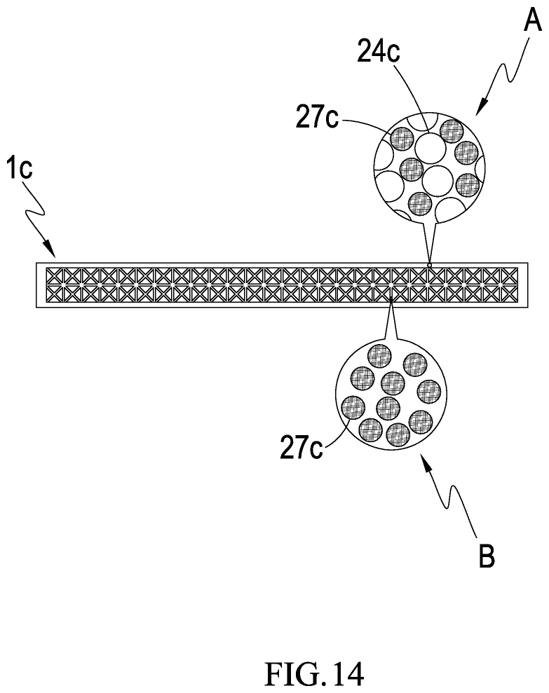

As shown in FIGS. 13 and 14, a plastic form according to a third embodiment is similar to the previous embodiments except that the first material A now includes mixed recycled polyamide (PA) particle 27c and fiberglass particles 24c, and the second material B now includes PA particles 27c. PA, also known as nylon, has good properties in terms of mechanics, heat resistance, abrasion resistance, chemical resistance, self-lubricating, and, especially, flame retarding. By using this material, the main member 1c may be applied as fire-resistant building material. In addition, the first partitions 13c of the present embodiment has a crisscross structure, further enhancing structural strength.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A plastic form, comprising:
an integrally formed flat main member comprising a first piece, a second piece facing the first piece in parallel, a plurality of first partitions fixedly arranged in parallel and at intervals between and perpendicularly connecting the first piece and the second piece, at least one second partition perpendicularly crossing the first partitions, and a plurality of channels, each surrounded by the first partitions and the at least one second partition with two openings respectively at its two ends, where the main member therefore has a mesh structure between the first and second pieces;
a first solid plate attached to an upper surface of the first piece;
a second solid plate attached to a lower surface of the second piece;
a plurality of polypropylene (PP) particles inside the main member, the first solid plate, and the second solid plate;
a plurality of polyethylene (PE) particles inside the main member;
a plurality of stone powder inside the first solid plate and the second solid plate;
a plurality of fiberglass particles inside the first solid plate and the second solid plate; and
a plurality of roughened faces configured on outer surfaces of the first solid plate and the second solid plate.

2. The plastic form according to claim 1, wherein two solid lateral pieces are respectively disposed at two lateral sides of the main member.

3. The plastic form according to claim 1, wherein the first solid plate and the second solid plate further comprise at least a dye.

4. A plastic form, comprising:
an integrally formed flat main member comprising a first piece, a second piece facing the first piece in parallel, a plurality of first partitions fixedly arranged in parallel and at intervals between and perpendicularly connecting the first piece and the second piece, at least one second partition perpendicularly crossing the first partitions, and a plurality of channels, each surrounded by the first partitions and the at least one second partition with two openings respectively at its two ends, where the main member therefore has a mesh structure between the first and second pieces;
a plurality of polycarbonate (PC) particles inside the main member, the first piece, and the second piece;
a plurality of fiberglass particles inside the first piece and the second piece; and
a plurality of roughened faces configured on outer surfaces of the first piece and the second piece.

5. The plastic form according to claim 4, wherein two solid lateral pieces are respectively disposed at two lateral sides of the main member.

6. The plastic form according to claim 4, wherein the first piece and the second piece further comprise at least a dye.

7. A plastic form, comprising:
an integrally formed flat main member comprising a first piece, a second piece facing the first piece in parallel, a plurality of first partitions fixedly arranged in parallel and at intervals between and perpendicularly connecting the first piece and the second piece, at least one second partition perpendicularly crossing the first partitions, and a plurality of channels, each surrounded by the first partitions and the at least one second partition with two openings respectively at its two ends, where the main member therefore has a mesh structure between the first and second pieces;
a plurality of polycarbonate (PC) particles inside the main member, the first piece, and the second piece;
a plurality of acrylonitrile butadiene styrene (ABS) resin particles inside the main member, the first piece, and the second piece;
a plurality of fiberglass particles inside the first piece and the second piece; and
a plurality of roughened faces configured on outer surfaces of the first piece and the second piece.

8. The plastic form according to claim 7, wherein two solid lateral pieces are respectively disposed at two lateral sides of the main member.

9. The plastic form according to claim 7, wherein the first piece and the second piece further comprise at least a dye.

10. A plastic form, comprising:
an integrally formed flat main member comprising a first piece, a second piece facing the first piece in parallel, a plurality of first partitions fixedly arranged in parallel and at intervals between and perpendicularly connecting the first piece and the second piece, at least one second partition perpendicularly crossing the first partitions, and a plurality of channels, each surrounded by the first partitions and the at least one second partition with two openings respectively at its two ends, where the main member therefore has a mesh structure between the first and second pieces;
a plurality of polyamide (PA) particles inside the main member, the first piece, and the second piece;
a plurality of fiberglass particles inside the first piece and the second piece; and
a plurality of roughened faces configured on outer surfaces of the first piece and the second piece.

11. The plastic form according to claim 10, wherein two solid lateral pieces are respectively disposed at two lateral sides of the main member.

12. The plastic form according to claim 10, wherein the first piece and the second piece further comprise at least a dye.

13. A method for manufacturing a plastic form, comprising the steps of:
(a) blending a first material and disposing the first material inside a single-screw extruder for melting;
(b) blending a second material and disposing the second material inside a twin-screw extruder for melting;
(c) evenly distributing the first material by at least one hydraulic distributor to an upper forming member and a lower forming member of a mesh forming machine;
(d) evenly delivering the second material by the at least one hydraulic distributor to a mesh forming member of the mesh forming machine;
(e) cooling and setting the first material and the second material by a cooling device after being output from the mesh forming machine; and
(f) producing a first piece from the upper forming member, a second piece from the lower forming member, a main member from the mesh forming member, and integrally forming the plastic form through the first piece, the second piece, and the main member, where the main member comprises a plurality of first partitions fixedly arranged in parallel and at intervals between and perpendicularly connecting the first piece and the second piece, at least one second partition perpendicularly crossing the first partitions, and a plurality of channels, each surrounded by the first partitions and the at least one second partition with two openings respectively at its two ends, and the main member therefore has a mesh structure.

14. The method according to claim 13, wherein the first piece comprises a first solid plate attached to an upper surface of the main member; and the second piece comprises a second solid plate attached to a lower surface of the main member.

15. The method according to claim 14, wherein the first material comprises mixed PP particles, stone powder, and fiberglass particles; and the second material comprises mixed PP particles and PE particles.

16. The method according to claim 13, wherein the first material comprises mixed PC particles and fiberglass particles; and the second material comprises PC particles.

17. The method according to claim 13, wherein the first material comprises mixed PC particles, ABS resin particles, and fiberglass particles; and the second material comprises mixed PC particles and ABS resin particles.

18. The method according to claim 13, wherein the first material comprises mixed PA particles and fiberglass particles; and the second material comprises PA particles.

19. The method according to claim 13, wherein two solid lateral pieces are respectively disposed at two lateral sides of the main member.

20. The plastic form according to claim 13, wherein the first piece and the second piece further comprise at least a dye.
